(19) United States
(12) Patent Application Publication
(10) Pub. No.: US 2006/0244842 A1
(43) Pub. Date: Nov. 2, 2006

(54) Color separation processing method and color separation processing circuit

(76) Inventor: Toshinobu Hatano, Kyoto (JP)

Correspondence Address: MCDERMOTT WILL & EMERY LLP, 600 13TH STREET, N.W., WASHINGTON, DC, 20005-3096, US

(21) Appl. No.: 11/410,918

(22) Filed: Apr. 26, 2006

(30) Foreign Application Priority Data
Apr. 28, 2005 (JP) 2005-132661

(51) Int. Cl. H04N 9/73

(52) U.S. Cl. 348/223.1

(57) ABSTRACT

The color separation processing method of the present invention comprises a calculation step of calculating an R-G color difference signal and a B-G color difference signal of color data of a Bayer array by a four-pixel unit that is a minimum unit of the RGB Bayer array. The calculation step comprises the steps of: separately sampling the color data of the four-pixel unit; separating three kinds of R-G color difference signals and three kinds of B-G color difference signals from the color data of the four-pixel unit; and selecting a color difference signal with the smallest absolute value among the three kinds of R-G color difference signals and a color difference signal with the smallest absolute value among the three kinds of B-G color difference signals as an R-G color difference signal and a B-G color difference signal within the four-pixel unit, respectively, for eliminating a false color signal caused due to a flaw signal, which is contained in the selected R-G color difference signal and the B-G color difference signal.

### BACKGROUND OF THE INVENTION

1. Field of the Invention

The present invention relates to a color separation processing method and a color separation processing circuit, which correspond to color data of RGB Bayer array for a digital camera.

2. Description of the Related Art

Recently, there has been a remarkable transition in the field of camera industry from analog technology to digital technology. Particularly, digital still cameras which require no photosensitive films have grown into a brisk business, and the main stream of portable telephones is those with digital cameras being mounted thereon.

Currently, the main streams of the digital cameras are those that employ signal processing corresponded to a sensor having a primary color filter for considering the color reproducibility. Considering the resolution, such camera requires a signal processing method with an excellent color S/N ratio.

The conventional color separation processing technique in a method for processing signals of the digital camera will be described hereinafter. FIG. 5 is a block diagram of a conventional color separation processing circuit disclosed in Japanese Published Patent Literature (Unexamined Publication 2002-16930). In FIG. 5, reference numeral 51 shows pixel data, 52 shows two-dimensional filter coefficients, 53 as well as 54, 55, and 56 are color interpolation circuits, 57-60 are subtraction devices, respectively, and 61, 62 are judging circuits.

The pixel data 51 has the RGB Bayer array arranged in 4×4 lines vertically and laterally. The two-dimensional filter coefficients 53 are arranged in 4×4 lines vertically and laterally. The color interpolation circuit 53 extracts only the R-components from the pixel data 51, multiplies the extracted R-components by the filter coefficients 52, and adds the multiplied results of the R-components of four pixels for generating and outputting the R-signal in the center position of the 4×4 array. The color interpolation circuit 54 extracts only the B-components from the pixel data 51, multiplies the extracted B-components by the filter coefficients 52, and adds the multiplied results of the B-components of four pixels for generating and outputting the B-signal in the center position of the 4×4 array. The color interpolation circuit 55 extracts only the G-components of four pixels in the upper left direction from the pixel data 51, multiplies the extracted G-components by the filter coefficients 52, and adds the multiplied results of the G-components of the four pixels for generating and outputting the G-signal in the center position of the 4×4 array. The color interpolation circuit 56 extracts only the G-components of four pixels in the lower right direction from the pixel data 51, multiplies the extracted G-components by the filter coefficients 52, and adds the results for generating and outputting the G-signal in the center position of the 4×4 array. The subtraction device 57 takes a difference between the R-signal and the G-signal in the lower right direction extracted by the color interpolation circuits 53, 56 for generating and outputting an R-G color difference signal. The subtraction device 58 takes a difference between the R-signal and the G-signal in the upper left direction extracted by the color interpolation circuits 53, 55 for generating and outputting an R-G color difference signal. The subtraction device 59 takes a difference between the B-signal and the G-signal in the upper left direction extracted by the color interpolation circuits 54, 55 for generating and outputting a B-G color difference signal. The subtraction device 60 takes a difference between the B-signal and the G-signal in the lower right direction extracted by the color interpolation circuits 54, 56 for generating and outputting a B-G color difference signal. The judging circuit 61 selectively outputs the R-G color difference signal with the smaller absolute value from the two kinds of R-B color difference signals outputted from the subtraction devices 57 and 58. The judging circuit 62 selectively outputs the B-G color difference signal with the smaller absolute value from the two kinds of B-G color difference signals outputted from the subtraction devices 59 and 60.

FIG. 6 is a block diagram for showing the fundamental structure of a digital camera. In FIG. 6, reference numeral 71 is an image sensor, 72 is a timing generator, 73 is a CDS/AGC circuit, 74 is an A/D converter (analog-digital converter), 75 is a DSP (digital signal processing circuit), 76 is a memory, and 77 is a microcomputer.

The timing generator 72 generates the driving pulse of the image sensor 71. The CDS/AGC circuit 73 eliminates noise of output signals of the image sensor 71 and controls the gain. The memory 76 saves the image data and various kinds of data. The microcomputer 77 controls the camera.

Action of the conventional color separation processing circuit constituted as described above will be described in the followings. Referring to FIG. 6, first, light making incident on the image sensor 71 through a lens is converted into electric signals by a photodiode, which are outputted then as analog continuous signals according to the vertical drive and horizontal drive. The drive timing pulse necessary for the action of the image sensor 71 is generated from the timing generator 72. The analog signal outputted from the image sensor 71 has 1/f noise reduced effectively by the sample hold (CDS) of the CDS/AGC circuit 73. The analog signal is then gain-controlled and inputted to the A/D converter 74 to be converted to a digital signal. The digital signal is inputted to the DSP 75. The DSP 75 performs each kinds of processing such as color separation, color matrix processing, luminance processing on the inputted digital signal via the memory 76.

Next, there will be described the color separation processing. When the color filter of the image sensor 71 is in the RGB Bayer array, the pixel data 51 captured through the image sensor is inputted through the memory 76 to the color separation processing circuit (built in the DSP 75) by keeping the Bayer array information. The processing in the color separation processing circuit is performed on the information of 4×4=16 pixels. The color interpolation circuits 53, 54, 55, and 56 multiplex the information of four pixels from the sixteen pixels described above for generating the R-signal, B-signal, upper-left G-signal, and lower-right G-signal. When multiplexing the information, the two-dimensional filter coefficients 52 are multiplied to each pixel so that the added information comes in the center of the pixel gravity.

Each signal of color-separated RGB becomes two kinds of R-G color difference signals and two kinds of B-G color difference signals due to the processing performed by the subtraction devices 57, 58, 59 and 60. Each of two kinds of color difference signals contains false color components due to position shift of the pixels in the Bayer array. The followings can be said based on the property of the false color components. That is, when there is more vertical-line information, the false component becomes less by selecting the G-signal in the vertical direction for the positions of the four pixels for each of R and B, and calculating the R-G color difference signal and the B-G color difference signal. Meanwhile, when there is more lateral-line information, the false component becomes less by selecting the G-signal in the lateral direction for the positions of the four pixels for each of R and B, and calculating the R-G color difference signal and the B-G color difference signal. Based on the above-described property, the judging circuits 61 and 62 finds the absolute values between the two kinds of the R-B color difference signals and between the two kinds of the B-G color difference signals, and determines those with the smaller absolute values as the R-B color difference signal and the B-G color difference signal of the information of 4×4=16 pixels, respectively.

In the conventional color separation processing circuit as described above, first, lowpass-filter processing is performed on a unit of sixteen pixels. Then, two kinds each of the R-G color difference signals and B-G color difference signals are generated, and those with the smaller absolute values are determined as the color difference signals of one unit (sixteen pixels), respectively.

In Japanese Published Patent Literature, further, there is performed the interpolation processing on the peripheral pixels so that each pixel in the RGB Bayer array contains picture data of a plurality of different colors, and two kinds of R-G color difference signals and two kinds of B-G color difference signals are generated. Then, weight is placed upon those with the smaller absolute values among the color difference signals to be determined as the color difference signals within one unit (sixteen pixels).

However, in the above-described conventional color separation processing method, the unit of processing in the RGB Bayer array is 4×4=16 pixels. Therefore, the pixel gravity is shifted by 0.5 pixel, thereby generating phase swing (displacement) in the image high-frequency component of the original information. As a result, in the case where the vertical-line information and the lateral-line information cross the sixteen pixels linearly, although the full effect of eliminating the false color component can be achieved, the residual component that cannot be eliminated by the filter processing is returned to the lowpass to emerge as unnatural noise with the swung phase (displacement).

### SUMMARY OF THE INVENTION

The main object of the present invention therefore is to reduce by a large amount the false color generated due to the phase swing and the high-frequency loop-back component.

In order to achieve the aforementioned object, the color separation processing method of the present invention comprises a calculation step of calculating an R-G color difference signal and a B-G color difference signal of color data of a Bayer array by a four-pixel unit that is a minimum unit of the RGB Bayer array, wherein
the calculation step comprises steps of:
separately sampling the color data of the four-pixel unit;
separating three kinds of R-G color difference signals and three kinds of B-G color difference signals from the color data of the four-pixel unit; and
selecting a color difference signal with a smallest absolute value among the three kinds of R-G color difference signals and a color difference signal with a smallest absolute value among the three kinds of B-G color difference signals as an R-G color difference signal and a B-G color difference signal within the four-pixel unit, respectively, for eliminating a false color signal caused due to a flaw signal, which is contained in the selected R-G color difference signal and the B-G color difference signal.

The three kinds of R-G color difference signals and the B-G color difference signals are set in the following manner, for example. That is, three kinds of G-signals are set based on the two G-signals within the four pixels and the average value thereof. Then, the three kinds of G-signals are subtracted from the R-signal and B-signal for setting the three kinds of color difference signals.

The color separation processing circuit of the present invention is a circuit for performing color separation processing of a color difference signal of an RGB Bayer array, which comprises
a switch circuit for separately sampling color data of four-pixel unit that is a minimum unit of the Bayer array;
a subtraction circuit for separating three kinds of R-G color difference signals and three kinds of B-G color difference signals from the color data of the four-pixel unit;
a selecting circuit for selecting a color difference signal with a smallest absolute value among the three kinds of R-G color difference signals and a color difference signal with a smallest absolute value among the three kinds of B-G color difference signals as an R-G color difference signal and a B-G color difference signal within the four-pixel unit, respectively; and
a filter circuit for eliminating a false color signal caused due to a flaw signal, which is contained in the selected R-G color difference signal and the B-G color difference signal.

As described above, in the present invention, color calculation is performed by four pixels as the minimum unit over a plurality of lines of the Bayer array for generating the three kinds of R-G color difference signals and B-G color difference signals. Then, the minimum value judging and selecting processing is performed and the two-dimensional LPF processing including the damage correction processing is performed at the later stage. With this, the false colors due to the phase swing and high-frequency loop-back component can be reduced dramatically. The present invention is effective as a technique for color separation processing that corresponds to the color data of the RGB Bayer array in a digital camera and the like.

### BRIEF DESCRIPTION OF THE DRAWINGS

Other objects of the present invention will become clear from the following description of the preferred embodiments and the appended claims. Those skilled in the art will appreciate that there are many other advantages of the present invention possible by embodying the present invention.

FIG. 1 is a block diagram for showing the fundamental structure of a color separation processing circuit according to a first embodiment of the present invention;

FIG. 2 is a detailed block diagram of the color separation processing circuit according to the first embodiment of the present invention;

FIG. 3A is a block diagram for showing the filter structure of the color separation processing circuit according to the first embodiment of the present invention;

FIG. 3B is an illustration for showing equivalent two-dimensional LPF coefficients of 4×4 according to the fist embodiment, to which vertical LPF processing and horizontal LPF processing is performed;

FIG. 3C is an illustration for showing the overall characteristic of the filter coefficients of the RGB Bayer array information of the adjacent five pixels in vertical and lateral directions according to the first embodiment;

FIG. 4A is a block diagram for showing the filter structure of a color separation processing circuit according to a second embodiment of the present invention;

FIG. 4B is an illustration for showing equivalent two-dimensional LPF coefficients of 4×4 according to the second embodiment, to which vertical LPF processing and horizontal LPF processing is performed;

FIG. 4C is an illustration for showing the overall characteristic of the filter coefficients of the RGB Bayer array information of the adjacent five pixels in vertical and lateral directions according to the second embodiment;

FIG. 5 is a block diagram for showing a conventional color separation processing circuit and a method thereof; and

FIG. 6 is a block diagram of the fundamental structure of a digital camera.

### DETAILED DESCRIPTION OF THE INVENTION

In the followings, a color separation processing circuit and a color separation processing method according to the embodiments of the present invention will be described specifically by referring to the accompanying drawings.

### First Embodiment

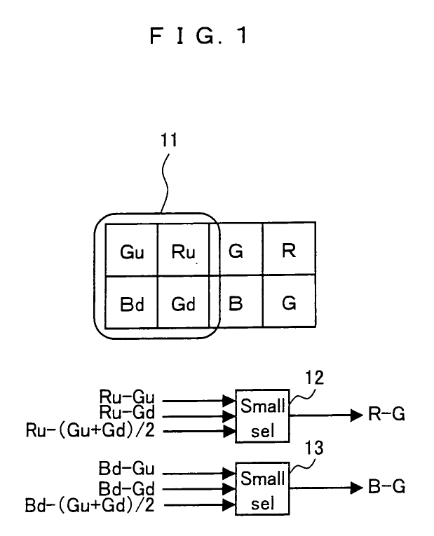

FIG. 1 is a block diagram for showing the fundamental structure of a color separation processing circuit according to a first embodiment of the present invention. The color separation processing circuit of the embodiment performs color separation processing on the smallest unit of the RGB Bayer array constituted of four pixels of pixel data. In FIG. 1, reference numeral 11 shows the smallest unit of the RGB Bayer array constituted of four pixels of pixel data.

The color separation processing circuit of the embodiment comprises a switch circuit 12 and a switch circuit 13. The switch circuit 12 selects the one with the smallest absolute value from three kinds of R-G color difference signals, and the switch circuit 13 selects the one with the smallest absolute value from three kinds of B-G color difference signals.

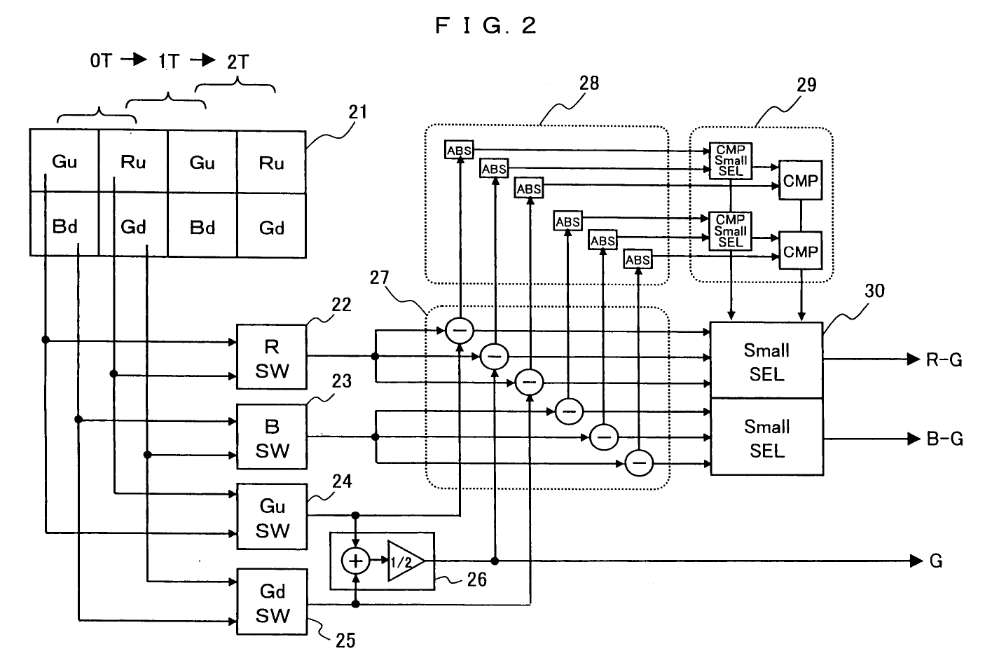

FIG. 2 shows the details of the color separation processing circuit of the embodiment. The color separation processing circuit comprises switch circuits 22-25, a G-signal average value circuit 26, subtraction circuits 27, absolute value circuits 28, minimum value judging circuits 29, and minimum value selecting circuits 30. The switch circuits 22-25 constitute the switch circuit of the present invention. The subtraction circuits constitute the subtraction circuit of the present invention, and the minimum value selecting circuits 30 constitute the selecting circuit of the present invention.

The switch circuit 22 always extracts the R-signal as the selected pixel information from the two pixels on the upper side of the minimum unit 21 when shifting in the minimum unit 21 in the horizontal direction according to the pixel clock. The switch circuit 23 always extracts the B-signal as the selected pixel information from the two pixels on the lower side of the minimum unit 21 when shifting in the minimum unit 21 in the horizontal direction according to the pixel clock. The switch circuit 24 always extracts the G-signal as the selected pixel information from the two pixels on the upper side of the minimum unit 21 when shifting in the minimum unit 21 in the horizontal direction according to the pixel clock. The switch circuit 25 always extracts the G-signal as the selected pixel information from the two pixels on the lower side of the minimum unit 21 when shifting in the minimum unit 21 in the horizontal direction according to the pixel clock. The G-signal average value circuit 26 calculates the average value of the G-signals selected by the switch circuits 24 and 25. The six subtraction circuits 27 generate three kinds of color difference signals of R-G and B-G, respectively, from the RGB signals selected or calculated by the switch circuits 22-25 and the G-signal average value circuit 26. The absolute value circuits 28 extract the absolute value of the R-G color difference signal and the absolute value of the B-G color difference signal. The minimum value judging circuits 29 judge the R-G color difference signal with the smallest absolute value and the B-G color difference signal with the smallest absolute value. The minimum value selecting circuits 30 select one color difference signal each from the three kinds of R-G color difference signals and B-G color difference signals based on the judgment results of the minimum value judging circuits 29.

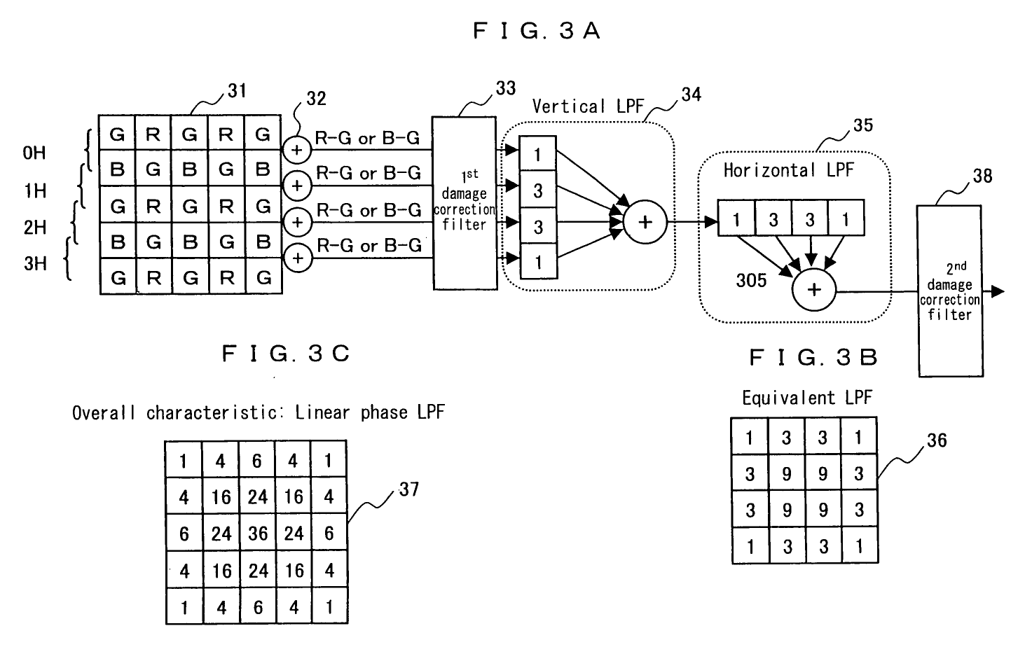

FIG. 3A is a block diagram for showing the filter circuit of a color separation processing apparatus according to the embodiment. The filter circuit of the color separation processing apparatus comprises four operation selecting circuits 32, a first damage correction filter 33, a vertical LPF 34, a horizontal LPF 35, and a second damage correction filter 38. The filter circuit structured in this way constitutes the filter circuit of the present invention.

The operation selecting circuits 32 generate three kinds of color difference signals of R-G and B-G, respectively, from the RGB signals selected or calculated by the switch circuits 22, 23, 24, 25 and the G-signal average value circuit 26. Then, the operation selecting circuits 32 select an arbitrary color difference signal respectively from the generated color difference signals and output as the color difference signals of interest.

The first damage correction filter 33 eliminates, using the peripheral same color pixels, the high-frequency component that is generated due to the damage correction processing and the shot noise from the R-G color difference signal of interest and the B-G color difference signal of interest outputted from the operation selecting circuits 32.

The vertical LPF 34 performs the vertical LPF processing on the R-G color difference signal of interest and the B-G color difference signal of interest outputted from the first damage correction filter 33. The vertical LPF processing is performed with the tap coefficients of 1, 3, 3, 1 where the pixel gravity becomes the center position.

The vertical LPF 35 performs the horizontal LPF processing on the R-G color difference signal of interest and the B-G color difference signal of interest to which the vertical LPF processing is performed. The horizontal LPF processing is performed with the tap coefficients of 1, 3, 3, 1 where the pixel gravity of the four adjacent-pixels on the right and left sides becomes the center position.

The second damage correction filter 38 eliminates the high-frequency component that is generated due to the damage correction processing and the shot noise from the R-G color difference signal of interest and the B-G color difference signal of interest to which the horizontal LPF processing is performed. The high-frequency component elimination processing is performed using the peripheral pixels (positioned in the vicinity of the pixels of interest) in the horizontal direction.

In FIG. 3A-3C, reference numeral 31 shows the RGB Bayer array information of adjacent five pixels in vertical and lateral directions. Reference numeral 36 shows the equivalent two-dimensional LPF coefficients of 4×4 when the processing of the vertical LPF 34 and the horizontal LPF 35 is performed, while 37 shows the overall coefficients added to the RGB Bayer array information 31 as a result of the color separation processing and the LPF processing.

Action of the color separation processing circuit structured as described above will be described hereinafter. First, there will be described the action of calculating each color difference signal of R-G and B-G from the color data of the RGB Bayer array 11 of four pixels.

In this case, the four switch circuits 22, 23, 24 and 25 are used for separately sampling each set of the pixel information of the minimum unit of the RGB Bayer array that is constituted with four pixels of pixel data. At the time of sampling, the information of four pixels is shifted in the horizontal direction for every clock, thereby changing the positions of the four pixels in the horizontal direction. Thus, there is performed switching in each of the switch circuits 22, 23, 24 and 25 according to the pixel clock, so that the four switch outputs outputted from the switch circuits 22, 23, 24 and 25 come to be the continuous signals of R, B, G1 and G2 at all times.

The average value circuit 26 generates the intermediate value based on the G1 signal and the G2 signal among the above-described four outputs (the continuous signals of R, B, G1 and G2). Thereby, three kinds of signals are generated as the G-signals. The subtraction circuits 27 generate three kinds of R-G color difference signals and B-G color difference signals, respectively, based on the above-described three kinds of G-signals. The absolute value circuits 28 generate the absolute values of the three kinds of R-G color difference values and the absolute values of the three kinds of B-G color difference values, respectively. The minimum value judging circuits 29 judge the color difference signals with the smallest absolute values, respectively, and output the R-G color difference signal judged as having the smallest value and the B-G color difference signal having the smallest value as the representative outputs of the minimum unit (four pixels) 21.

Next, there will be described the action of the case where the color separation processing of the R-G color difference signal and the B-G color difference signal by a unit of four pixels is performed simultaneously for the four-pixel unit in the adjacent five lines.

As shown in FIG. 3A, RGB Bayer array information 31. (5×5 pixels) is separated into a line-pair positioned in the first to second lines, a line-pair positioned in the second to third lines, a line-pair of the third to fourth lines, and a line-pair of the fourth to fifth lines. Then each line-pair is set as the unit of four pixels 0H (the line-pair of the first-second lines), 1H (the line-pair of the second-third lines), 2H (the line-pair of the third-fourth lines), and 3H (the line-pair of the fourth-fifth lines). Each of the set four-pixel units 0H, 1H, 2H and 3H are shifted through by each pixel clock.

There is performed the processing for separating the R-G color difference signal and the B-G color difference signal from the four-pixel units 0H, 1H, 2H and 3H, which are set in the manner as described above, by synchronizing with the pixel clock. After performing the separation processing of the color difference signals, the four-pixel units 0H, 1H, 2H and 3H are reset in each line-pair through shifting by one pixel along the line. The above-described separation processing of the color difference signals is performed again on the reset four-pixel units 0H, 1H, 2H and 3H.

Such separation processing of the color difference signals is performed in each line-pair by synchronizing with each other in terms of positions. That is, in each line-pair, the positions of the four-pixel units to which the separation processing of the color difference signals is performed in each pixel clock are aligned in the longitudinal direction (vertical direction).

After performing the above-described separation processing of the color difference signals on the entire RGB Bayer array information 31 (5×5 pixels), among the group of the obtained R-G color difference signals and the group of the B-G color difference signals in each line-pair, the R-G color difference signal and the B-G color difference signal with the smallest absolute values are selected and outputted as the R-G color difference signal of interest and the B-G color difference signal of interest. The R-G color difference signal of interest and the B-G color difference signal of interest are outputted by each line-pair.

The selection and output of the color difference signals of interest described above are performed by the four operation selecting circuits 32. The color difference signals of interest are outputted from each operation selecting circuit 32 to the first damage correction filter 33.

The first damage correction filter 33 eliminates the high-frequency components generated due to the damage correction and the shot noise from the R-G color difference signals of interest and the B-G color difference signals of interest in each line-pair. The high-frequency component is eliminated using the peripheral same color pixels. The R-G color difference signals of interest and the B-G color difference signals of interest from which the high-frequency components are eliminated are outputted to the vertical LPF 34 from the first damage correction filter 33.

The vertical LPF 34 performs the vertical LPF processing on the R-G color difference signal of interest and the B-G color difference signal of interest for eliminating the high-frequency components of the colors along the vertical direction. The tap coefficients of the vertical LPF processing performed herein are 1, 3, 3, 1 with the pixel gravity being the center position. The R-G color difference signal of interest and the B-G color difference signal of interest to which the vertical LPF processing is performed are outputted to the horizontal LPF 35.

The horizontal LPF 35 performs the horizontal LPF processing on the R-G color difference signal of interest and the B-G color difference signal of interest for eliminating the high-frequency components of the colors along the horizontal direction. The tap coefficients of the horizontal LPF processing performed herein are 1, 3, 3, 1 with the pixel gravity of the adjacent four pixels on left and right sides being the center position.

FIG. 3B shows the equivalent two-dimensional LPF coefficients 36 of 4×4 to which the vertical LPF processing and the horizontal LPF processing is performed. Further, as a result of performing the color separation processing and the vertical/horizontal LPF processing described above, the filter-coefficient overall characteristic 37 of the RGB Bayer array information 31 of adjacent five pixels in the vertical and lateral directions become the values shown in FIG. 3C.

The filter coefficient overall characteristic 37 is set in the following manner. That is, when [1, 3, 3, 1, 0] and [0, 1, 3, 3, 1] being shifted by one in terms of position are added, there is obtained [1+0, 3+1, 3+3, 1+3, 0+1]=[1, 4, 6, 4, 1]. This set of [1, 4, 6, 4, 1] is arranged in vertical and lateral directions and the values of product are set at the points of the intersection of the vertical and lateral directions for setting the filter coefficient overall characteristic 37.

For example, the second row of the second column is 4×4=16, the second row of the third column is 4×6=24, the third row of the second column is 6×4=24, and the third row of the third column is 6×6=36.

The R-G color difference signal of interest and the B-G color difference signal of interest to which the horizontal LPF processing is performed are outputted to the second damage correction filter 38. The second damage correction filter 38 eliminates the high-frequency component (due to the damage correction processing and the shot noise) from the R-G color difference signal of interest and the B-G color difference signal of interest. The high-frequency component is eliminated using the peripheral pixels (positioned in the vicinity of the pixels of interest) in the horizontal direction. The high-frequency components are eliminated in the first damage correction filter 33 and the second damage correction filter 38, respectively, thereby achieving high effect of reducing the noise.

It may be set as selective to eliminate the high-frequency components in the first damage correction filter 33 alone, the second damage correction filter 38 alone, or in both filters in accordance with the scene to be picked up.

### Second Embodiment

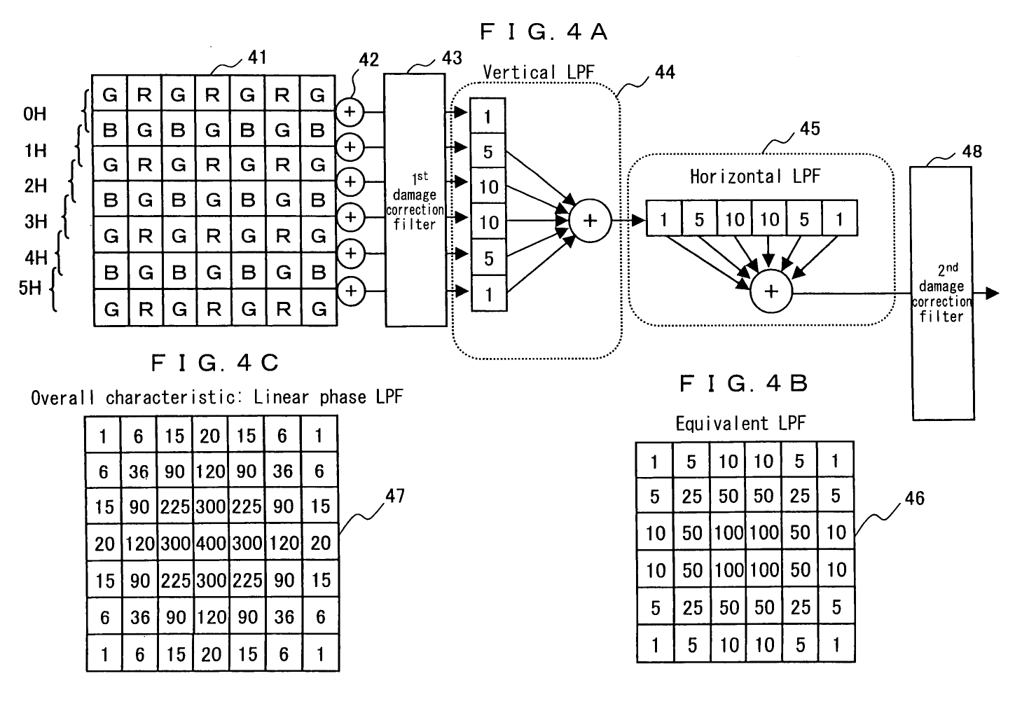

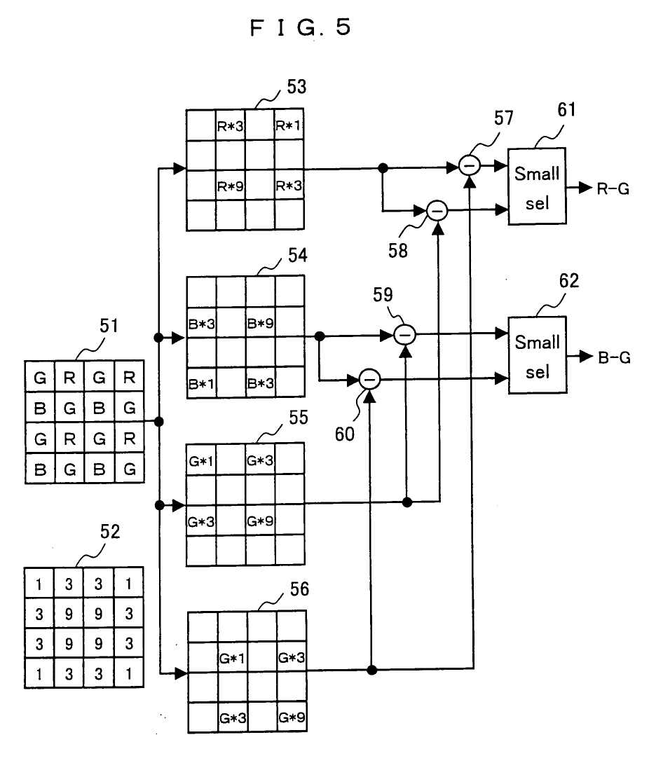

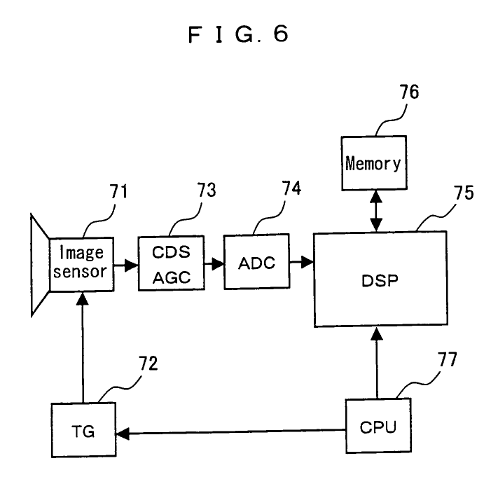

FIG. 4A is a block diagram for showing the filter circuit of a color separation processing apparatus according to a second embodiment of the present invention. In FIG. 4A - 4C, reference numeral 41 shows the RGB Bayer array information of adjacent seven pixels in the vertical and lateral directions. Reference numeral 46 shows the equivalent two-dimensional LPF coefficients of 6×6 when the processing of the vertical LPF 44 and the processing of the horizontal LPF 45 is performed, and 47 shows the overall coefficients placed upon the RGB Bayer array information 41 as a result of the color separation processing and the LPF processing.

The filter of the color separation processing apparatus according to the second embodiment comprises six operation selecting circuits 42, a first damage filter 43, a vertical LPF 44, a horizontal LPF 45, and a second damage correction filter 48.

The operation selecting circuits 42 generate three kinds of color difference signals of R-G and B-G, respectively, from the RGB signals selected or calculated by the switch circuits 22, 23, 24, 25 and the G-signal average value circuit 26. Then, the operation selecting circuits 32 output an arbitrary color difference signal respectively from the generated color difference signals and output as the color difference signals of interest.

The first damage correction filter 43 eliminates, using the peripheral same color pixels, the high-frequency component that is generated due to the damage correction processing and the shot noise from the R-G color difference signal of interest and the B-G color difference signal of interest outputted from the operation selecting circuits 42.

The vertical LPF 44 performs the vertical LPF processing on the R-G color difference signal of interest and the B-G color difference signal of interest outputted from the first damage correction filter 43. The vertical LPF processing is performed with the tap coefficients of 1, 5, 10, 10, 5, 1 where the pixel gravity becomes the center position.

The vertical LPF 45 performs the horizontal LPF processing on the R-G color difference signal of interest and the B-G color difference signal of interest to which the vertical LPF processing is performed. The horizontal LPF processing is performed with the tap coefficients of 1, 5, 10, 10, 5, 1 where the pixel gravity of six adjacent pixels on the right and left sides becomes the center position.

The second damage correction filter 48 eliminates the high-frequency component that is generated due to the damage correction processing and the shot noise from the R-G color difference signal of interest and the B-G color difference signal of interest to which the horizontal LPF processing is performed. The high-frequency component elimination processing is performed using the peripheral pixels (positioned in the vicinity of the pixels of interest) in the horizontal direction.

As described above, the configuration of the second embodiment is the same as that of the first embodiment (the configuration shown in FIG. 1 and FIG. 2), and the action for calculating each color difference signal of R-G and B-G from the color data of the RGB Bayer array 11 of four pixels is also the same as that of the first embodiment.

Next, there will be described the action of the case where the color separation processing of the R-G color difference signal and the B-G color difference signal by a unit of four pixels is performed simultaneously for the four-pixel unit in the adjacent seven lines.

As shown in FIG. 4A, RGB Bayer array information 41 (7×7 pixels) is separated into a line-pair positioned in the first to second lines, a line-pair positioned in the second to third lines, a line-pair of the third to fourth lines, a line-pair of the fourth to fifth lines, a line-pair of the fifth to sixth lines, and a line-pair of sixth to seventh lines. Then, each line-pair is set as the unit of four pixels 0H (the line-pair of the first-second lines), 1H (the line-pair of the second-third lines), 2H (the line-pair of the third-fourth lines), 3H (the line-pair of the fourth-fifth lines), 4H (the line-pair of the fifth-sixth lines), and 5H (the line-pair of the sixth-seventh lines). Each of the set four-pixel units 0H, 1H, 2H, 3H, 4H and 5H are shifted through by each pixel clock.

There is performed the processing for separating the R-G color difference signal and the B-G color difference signal from the four-pixel units 0H, 1H, 2H, 3H, 4H and 5H, which are set in the manner as described above, by synchronizing with the pixel clock. After performing the separation processing of the color difference signals, the four-pixel units 0H, 1H, 2H, 3H, 4H and 5H are reset in each line-pair through shifting by one pixel along the line. The above-described separation processing of the color difference signals is performed again on the reset four-pixel units 0H, 1H, 2H, 3H, 4H and 5H.

Such separation processing of the color difference signals is performed in each line-pair by synchronizing with each other in terms of positions. That is, in each line-pair, the positions of the four-pixel units to which the separation processing of the color difference signals is performed in each pixel clock are aligned in the longitudinal direction (vertical direction).

After performing the above-described separation processing of the color difference signals on the entire RGB Bayer array information 41 (7×7 pixels), among the group of the obtained R-G color difference signals and the group of the B-G color difference signals in each line-pair, the R-G color difference signal and the B-G color difference signal with the smallest absolute values are selected to be outputted as the R-G color difference signal of interest and the B-G color difference signal of interest. The R-G color difference signal of interest and the B-G color difference signal of interest are outputted by each line-pair.

The selection and output of the color difference signals of interest described above are performed by the six operation selecting circuits 42. The color difference signals of interest are outputted from each operation selecting circuit 42 to the first damage correction filter 43.

The first damage correction filter 43 eliminates the high-frequency components generated due to the damage correction and the shot noise from the R-G color difference signals of interest and the color difference signals of interest in each line-pair. The high-frequency component is eliminated using the peripheral same color pixels. The R-G color difference signals of interest and the color difference signals of interest from which the high-frequency components are eliminated are outputted to the vertical LPF 44 from the first damage correction filter 43.

The vertical LPF 44 performs the vertical LPF processing on the R-G color difference signal of interest and the B-G color difference signal of interest for eliminating the high-frequency components of the colors along the vertical direction. The tap coefficients of the vertical LPF processing performed herein are 1, 5, 10, 10, 5, 1 with the pixel gravity being the center position. The R-G color difference signal of interest and the B-G color difference signal of interest to which the vertical LPF processing is performed are outputted to the horizontal LPF 45.

The horizontal LPF 45 performs the horizontal LPF processing on the R-G color difference signal of interest and the B-G color difference signal of interest for eliminating the high-frequency components of the colors along the horizontal direction. The tap coefficients of the horizontal LPF processing performed herein are 1, 5, 10, 10, 5, 1 with the pixel gravity of the adjacent six pixels on left and right sides being the center position.

FIG. 4B shows the equivalent two-dimensional LPF coefficients 46 of 6×6 to which the vertical LPF processing and the horizontal LPF processing is performed. Further, as a result of performing the color separation processing and the vertical/horizontal LPF processing described above, the filter-coefficient overall characteristic 47 of the RGB Bayer array information 41 of adjacent seven pixels in the vertical and lateral directions become the values shown in FIG. 4C.

The filter coefficient overall characteristic 47 is set in the following manner. That is, when [1, 5, 10, 10, 5, 1, 0] and [0, 1, 5, 10, 10, 5, 1] being shifted by one in terms of position are added, there is obtained [1+0, 5+1, 10+5, 10+10, 5+10, 1+5, 0+1]=[1, 6, 15, 20, 15, 6, 1]. This set of [1, 6, 15, 20, 15, 6, 1] is arranged in vertical and lateral directions and the values of product are set at the points of the intersection of the vertical and lateral directions for setting the filter coefficient overall characteristic 47.

For example, the second row of the second column is 6×6=36, the second row of the third column is 6×15=90, the second row of the fourth column is 6×20=120, the third row of the second column is 15×6=90, the third row of the third column is 15×15=225, the third row of the fourth column is 15×20=300, the fourth row of the second column is 20×6=120, the fourth row of the third column is 20×15=300, and the fourth row of the fourth column is 20×20=400.

The R-G color difference signal of interest and the B-G color difference signal of interest to which the horizontal LPF processing is performed are outputted to the second damage correction filter 48. The second damage correction filter 48 eliminates the high-frequency component (due to the damage correction processing and the shot noise) from the R-G color difference signal of interest and the B-G color difference signal of interest. The high-frequency component is eliminated using the peripheral pixels (positioned in the vicinity of the pixels of interest) in the horizontal direction. The high-frequency components are eliminated in the first damage correction filter 43 and the second damage correction filter 48, respectively, thereby achieving high effect of reducing the noise.

It may be set as selective to eliminate the high-frequency components in the first damage correction filter 43 alone, the second damage correction filter 48 alone, or in both filters in accordance with the scene to be picked up.

With above-described first and the second embodiments, the high-frequency components of the unnecessary luminance can be suppressed dramatically in the color difference signal band contained in the RGB Bayer information through arranging and performing in order the color separation processing carried out by a unit of four pixels, the first damage correcting processing, the vertical LPF processing, the horizontal LPF processing, and the second damage correction processing along a time series.

Furthermore, since the LPF processing is performed on the original pixels with the pixel gravity being at the position of the pixel of interest, there is no phase swing generated due to the filter processing of the RGB signal. Therefore, the natural and beautiful false-color suppressing effect can be expected.

The present invention has been described in detail by referring to the most preferred embodiments. However, various combinations and modifications of the components are possible without departing from the sprit and the broad scope of the appended claims.

What is claimed is:

1. A color separation processing method, comprising a calculation step of calculating an R-G color difference signal and a B-G color difference signal of color data of a Bayer array by a four-pixel unit that is a minimum unit of said RGB Bayer array, wherein
said calculation step comprises steps of:
separately sampling said color data of said four-pixel unit;
separating three kinds of R-G color difference signals and three kinds of B-G color difference signals from said color data of said four-pixel unit; and
selecting a color difference signal with a smallest absolute value among said three kinds of R-G color difference signals and a color difference signal with a smallest absolute value among said three kinds of B-G color difference signals as an R-G color difference signal and a B-G color difference signal within said four-pixel unit, respectively, for eliminating a false color signal caused due to a flaw signal, which is contained in selected said R-G color difference signal and said B-G color difference signal.

2. The color separation processing method according to claim 1, wherein, when performing processing for separating said R-G color difference signal and said B-G color difference signal by said four-pixel unit, said processing is performed simultaneously on adjacent N-number of odd lines for generating said selected R-G color difference signals for N−1 lines and said selected B-G color difference signals for N−1 lines and, then, LPF processing with two-dimensional tap number of (N−1)×(N−1) with pixel gravity being at a center position is performed on said selected R-G color difference signals and said selected B-G color difference signals.

3. The color separation processing method according to claim 1, wherein, when performing processing for separating said R-G color difference signal and said B-G color difference signal by said four-pixel unit, said processing is performed simultaneously on adjacent five lines for generating said selected R-G color difference signals for four lines and said selected B-G color difference signals for four lines and, then, LPF processing with two-dimensional tap number of 4×4 with pixel gravity being at a center position is performed on said selected R-G color difference signals and said selected B-G color difference signals.

4. The color separation processing method according to claim 1, wherein, when performing processing for separating said R-G color difference signal and said B-G color difference signal by said four-pixel unit, said processing is performed simultaneously on adjacent seven lines for generating said selected R-G color difference signals for six lines and said selected B-G color difference signals for six lines and, then, LPF processing with two-dimensional tap number of 6×6 with pixel gravity being at a center position is performed on said selected R-G color difference signals and said selected B-G color difference signals.

5. The color separation processing method according to claim 1, wherein, when performing processing for separating said R-G color difference signal and said B-G color difference signal by said four-pixel unit, said processing is performed simultaneously on adjacent nine lines for generating said selected R-G color difference signals for eight lines and said selected B-G color difference signals for eight lines and, then, LPF processing with two-dimensional tap number of 8×8 with pixel gravity being at a center position is performed on said selected R-G color difference signals and said selected B-G color difference signals.

6. The color separation processing method according to claim 3, wherein, when performing said LPF processing with two-dimensional tap number of 4×4 with pixel gravity being at a center position, one-dimensional FIR filter processing having a coefficient ratio of 1:3:3:1 as tap coefficients thereof is carried out in vertical and horizontal directions, respectively, so that 5×5 LPF processing with coefficient ratio of 1:4:6:4:1 having pixel gravity being at a center position is performed on each of said color difference signals of original pixels in said Bayer array.

7. The color separation processing method according to claim 4, wherein, when performing said LPF processing with two-dimensional tap number of 6×6 with pixel gravity being at a center position, one-dimensional FIR filter processing having a coefficient ratio of 1:5:10:10:5:1 as tap coefficients thereof is carried out in vertical and horizontal directions, respectively, so that 7×7 LPF processing with coefficient ratio of 1:6:15:20:15:6:1 having pixel gravity being at a center position is performed on each of said color difference signals of original pixels in said Bayer array.

8. The color separation processing method according to claim 5, wherein, when performing said LPF processing with two-dimensional tap number of 8×8 with pixel gravity being at a center position, one-dimensional FIR filter processing having a coefficient ratio of 1:7:21:35:35:21:7:1 as tap coefficients thereof is carried out in vertical and horizontal directions, respectively, so that 9×9 LPF processing with coefficient ratio of 1:8:28:56:70:56:28:8:1 having pixel gravity being at a center position is performed on each of said color difference signals of original pixels in said Bayer array.

9. A color separation processing circuit for performing color separation processing of a color difference signal of an RGB Bayer array, comprising
a switch circuit for separately sampling color data of four-pixel unit that is a minimum unit of said Bayer array;
a subtraction circuit for separating three kinds of R-G color difference signals and three kinds of B-G color difference signals from said color data of said four-pixel unit;
a selecting circuit for selecting a color difference signal with a smallest absolute value among said three kinds of R-G color difference signals and a color difference signal with a smallest absolute value among said three kinds of B-G color difference signals as an R-G color difference signal and a B-G color difference signal within said four-pixel unit, respectively; and
a filter circuit for eliminating a false color signal caused due to a flaw signal, which is contained in selected said R-G color difference signal and said B-G color difference signal.

10. The color separation processing circuit according to claim 9, wherein:
when performing processing for separating said R-G color difference signal and said B-G color difference signal by said four-pixel unit, said selecting circuit performs processing simultaneously on adjacent N-number of odd lines for generating said selected R-G color difference signals for N−1 lines and said selected B-G color difference signals for N−1 lines; and
said filter circuit performs LPF processing with two-dimensional tap number of (N−1)×(N−1) with pixel gravity being at a center position on said selected R-G color difference signals and said selected B-G color difference signals.

11. The color separation processing circuit according to claim 9, wherein:
when performing processing for separating said R-G color difference signal and said B-G color difference signal by said four-pixel unit, said selecting circuit performs processing simultaneously on adjacent five lines for generating said selected R-G color difference signals for four lines and said selected B-G color difference signals for four lines; and
said filter circuit performs LPF processing with two-dimensional tap number of 4×4 with pixel gravity being at a center position on said selected R-G color difference signals and said selected B-G color difference signals.

12. The color separation processing circuit according to claim 9, wherein:
when performing processing for separating said R-G color difference signal and said B-G color difference signal by said four-pixel unit, said selecting circuit performs processing simultaneously on adjacent seven lines for generating said selected R-G color difference signals for six lines and said selected B-G color difference signals for six lines; and
said filter circuit performs LPF processing with two-dimensional tap number of 6×6 with pixel gravity being at a center position on said selected R-G color difference signals and said selected B-G color difference signals.

13. The color separation processing method according to claim 9, wherein:
when performing processing for separating said R-G color difference signal and said B-G color difference signal by said four-pixel unit, said selecting circuit performs processing simultaneously on adjacent nine lines for generating said selected R-G color difference signals for eight lines and said selected B-G color difference signals for eight lines; and
said filter circuit performs LPF processing with two-dimensional tap number of 8×8 with pixel gravity being at a center position on said selected R-G color difference signals and said selected B-G color difference signals.

14. The color separation processing circuit according to claim 11, wherein, when performing said LPF processing with two-dimensional tap number of 4×4 with pixel gravity being at a center position, said filter circuit performs one-dimensional FIR filter processing having a coefficient ratio of 1:3:3:1 as tap coefficients thereof in vertical and horizontal directions, respectively, so that 5×5 LPF processing with coefficient ratio of 1:4:6:4:1 having pixel gravity being at a center position is performed on each color data of original pixels in said Bayer array.

15. The color separation processing method according to claim 12, wherein, when performing said LPF processing with two-dimensional tap number of 6×6 with pixel gravity being at a center position, said filter circuit performs one-dimensional FIR filter processing having a coefficient ratio of 1:5:10:10:5:1 as tap coefficients thereof in vertical and horizontal directions, respectively, so that 7×7 LPF processing with coefficient ratio of 1:6:15:20:15:6:1 having pixel gravity being at a center position is performed on each color data of original pixels in said Bayer array.

16. The color separation processing method according to claim 13, wherein, when performing said LPF processing with two-dimensional tap number of 8×8 with pixel gravity being at a center position, said filter circuit performs one-dimensional FIR filter processing having a coefficient ratio of 1:7:21:35:35:21:7:1 as tap coefficients thereof in vertical and horizontal directions, respectively, so that 9×9 LPF processing with coefficient ratio of 1:8:28:56:70:56:28:8:1 having pixel gravity being at a center position is performed on each color data of original pixels in said Bayer array.

17. The color separation processing circuit according to claim 10, wherein
said filter circuit performs, as elimination processing of said false color signal caused due to said flaw signal;
damage correction processing at a previous stage of said LPF processing by placing weight on a pixel in a vicinity of center and using peripheral same color pixel information; and
damage correction processing at a later stage of said LPF processing by placing weight on a center pixel and using peripheral same color pixel information positioned in a vicinity of a pixel of interest in a horizontal direction, wherein
said filter circuit selectively carries out said damage correction processing performed at a previous stage of said LPF processing and said damage correction processing performed at a later stage of said LPF processing.
